(19) United States
(12) Patent Application Publication
(10) Pub. No.: US 2003/0041005 A1
(43) Pub. Date: Feb. 27, 2003

(54) Rating system and method for on-line services auction marketplace

(76) Inventors: Travis J. Parry, Boise, ID (US); Robert Sesek, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/934,032

(22) Filed: Aug. 21, 2001

(51) Int. Cl. G06F 17/60

(52) U.S. Cl. 705/37

(57) ABSTRACT

An implementation of a technology, described herein, for providing a common rating scale for services to facilitate the buying and selling of services via an on-line auction. At least one implementation of the invention, described herein, is an on-line auction (such as an Internet auction), where services are the subject of such auction. More specifically, the services have a highly variable valuation (e.g., a “time-sensitive” value). In the implementation, described herein, a common rating scale is provided so that the value (and, in particular, the time-sensitive nature of the value) of such services may be specified. Thus, this gives a common unit of measurement for perceived valuation of a service. This abstract itself is not intended to limit the scope of this patent. The scope of the present invention is pointed out in the appending claims.

### TECHNICAL FIELD

This invention generally relates to a technology for providing a common rating scale for services to facilitate the buying and selling of services via an online auction.

### BACKGROUND

Typically, advertisers pay for the value and quantity of advertisements, such as those on radio and television. Quantity is, of course, easy to measure. However, value is not necessarily easy to quantify. For television and radio, the value is often determined by the estimated viewership and the placement of the advertisement. Advertisers tend to pay more when their advertisements are viewed by more people than others. They also pay more when their advertisements are seen by their desired demographics.

The pricing of advertisement depends on how many viewers are estimated to be in the audience, how much commercial time is available for purchase, and how many advertisers want to purchase it. A 30-second spot in the Super Bowl goes for $2,000,000 or more. A 30-second spot on the highest-rated primetime broadcast network drama may cost $600,000. A similar spot on the highest-rated primetime broadcast network game show may go for $250,000. Overall, the average price for a 30-second spot on one of the big network prime-time shows is over $150,000.

However, daytime and late-night spots in local markets are much less expensive. In a medium-sized market, $5 per thousand viewers is not unusual. So, a 30-second slot in daytime that reaches 10,000 viewers might cost an advertiser around $50 to $60. An advertiser may be able to buy “overnight” time slots—between midnight and 5 AM—for as little as $1 each.

Also, the value of time slots will vary based upon other variables other than time. For example, a late night event that would typically not garner a large audience may do so because it is one of great interest. For example, Olympic events overseas may draw a larger than normal audience for a specific time frame. Thus, advertising is a prime example of a service with a wide range of perceived value based upon the time (and the factors related to that time) that the advertisement is presented. Thus, advertising has a “time-sensitive” value.

### Services with Time-Insensitive Valuation

There are some services where everyone expects a relatively high-degree of quality each time the service is performed. In addition, the value of these services does not vary based upon the time that they are performed. Therefore, these services tend to vary little (if at all) in value that a person is willing to pay for such services. These services have “time-insensitive” values. Examples of such services include babysitting, medical care, dentistry, lawn care, inventing, and the like.

Of course, these otherwise “time-insensitive” services may vary slightly depending upon when they are performed. Also, their value may greatly increase in an emergency situation.

### Services with Time-Sensitive Valuation

However, with many other services, people expect a range of value depending upon when the service is performed. These services have a “timesensitive” value. Examples of such services include (by way of example and not by limitation): advertising in movie houses, advertising in local & regional media (publications, radio, television, and the like), Web page design, patent application drafting, graphic design, computer programming, legal services, inventing, and the like.

Movie Advertisements

Often before a motion picture presentation begins, the awaiting audience is entertained by images projected onto a movie screen. The images sometimes include trivia questions and quick puzzles, particularly those that are film-related. Many times, the images include (by way of example and not by limitation) advertisements for local establishments, such as restaurants, manicurists, hair stylists, auto service, insurance, and such. The advertisements may be almost anything, even help wanted ads.

The value of such advertisements varies depending upon the time of day and which movie it is associated with. Thus, the value of given advertisement time slots varies. Therefore, advertising with movies is a service with a time-sensitive valuation.

Other Services

Like movie advertising, other services have a time-sensitive valuation.

Advertising with broadcast media is an example of one such service. Broadcast media may include radio, television, and the Internet.

Businesses often wish to direct their advertising to the readers of publications. The placement of advertisement in the publication is analogous to the placement of time slots for broadcast media. The reader will see the advertisement at a specific time relative to the others. Examples of such publications include a city newspaper or a magazine.

In addition to advertising, the brokering of stocks, bonds, commodities, and the like is another service with a time-sensitive valuation. When the service is performed is may greatly affect the value of the service. The shipping of goods is another service with a time-sensitive valuation.

Traditionally, services—such as these with a time-sensitive valuation—are not sold to the highest bidder via an on-line auction. Instead of services, only goods are typically bought and sold via such auctions.

### Traditional Physical Auctions

Traditional physical auctions—where people gather in an auction hall to bid—may include either goods or services. Of course, the auctioning of goods at traditional auctions is commonplace. Christie's™ and Sotherby's™ are auction houses that are famous for selling noteworthy, expensive, famous, and infamous items (i.e., goods).

It is not uncommon for services to auction off at charity auction. Individuals and business may offer their services for sale in an auction format with the proceeds going towards a charitable cause. In these instances, the auctioned services are those that must be performed at or near the one receiving the services. In other words, these services have a value that is time-insensitive.

In addition, the parties to a service must arrange for a mutually acceptable time frame for the services to be performed. The time frame and delivery are not typically agreed upon (or specified) at the time of the bidding.

### Conventional Goods-Based On-Line Auctions

There are many Internet sites for conventional on-line auctions (e.g., Internet auctions). One of the most well known is Ebay™ (www.ebay.com). All of these conventional on-line auctions are goods-based, which means that goods, rather than services, are auctioned.

On such auctions, nearly anyone in the on-line world can post a physical item (i.e., a good) for-sale and others bid on that item in an auction-type style. Typically, the highest bidder can purchase the item from the seller at a price equal to their winning bid. In these instances, the seller and buyer arrange for delivery of such goods to the buyer. Typically, the goods are shipped via the U.S. Postal Service or another equivalent service.

After the auction for an item is complete, the transaction must be completed by the parties. For example, one may ship the goods to the other while money is exchanged.

### Need for Services-Based On-Line Auctions

Services are not the subject of conventional on-line auctions. One reason for this may be that services typically require a physical presence of a service provider to perform such service. In other words, there services are proximity-dependent.

Since the Internet is boundary-less and regionally anonymous by its nature, the travel required to perform a service may be cumbersome or even economically infeasible. Furthermore, it is difficult for one to find and identify an entity willing to perform a particular service within a particular region.

However, there are some services where proximity is not important. These are “proximity-independent” services.

Accordingly, there is a need for a real-time auction (such as an Internet auction), where services are the subject of such auction. Furthermore, there is a particular need to provide a common rating scale so that the value (and, in particular, the time-sensitive nature of the value) of such services may be specified.

### SUMMARY

Described herein is a technology for providing a common rating scale for services to facilitate the buying and selling of services via an on-line auction.

At least one implementation of the invention, described herein, is an on-line auction (such as an Internet auction), where services are the subject of such auction. More specifically, the services have a highly variable valuation (e.g., a “time-sensitive” value). In the implementation, described herein, a common rating scale is provided so that the value (and, in particular, the time-sensitive nature of the value) of such services may be specified. Thus, this gives a common unit of measurement for perceived valuation of a service.

This summary itself is not intended to limit the scope of this patent. Moreover, the title of this patent is not intended to limit the scope of this patent. For a better understanding of the present invention, please see the following detailed description and appending claims, taken in conjunction with the accompanying drawings. The scope of the present invention is pointed out in the appending claims.

### BRIEF DESCRIPTION OF THE DRAWINGS

The same numbers are used throughout the drawings to reference like elements and features.

FIG. 1 is a schematic block diagram showing an on-line services auction marketplace and a services rater in accordance with an implementation of the invention herein.

FIG. 2 is a schematic block diagram showing the on-line services auction marketplace and a services rater in accordance with another implementation of the invention herein.

FIG. 3 is a flow chart illustrating a methodological implementation in accordance with an implementation of the invention herein.

FIG. 4 is an example of a computing operating environment capable of implementing an implementation (wholly or partially) of the invention herein.

### DETAILED DESCRIPTION

In the following description, for purposes of explanation, specific numbers, materials and configurations are set forth in order to provide a thorough understanding of the present invention. However, it will be apparent to one skilled in the art that the present invention may be practiced without the specific exemplary details. In other instances, well-known features are omitted or simplified to clarify the description of the exemplary implementations of the present invention, thereby better explaining the present invention. Furthermore, for ease of understanding, certain method steps are delineated as separate steps; however, these separately delineated steps should not be construed as necessarily order dependent in their performance.

The following description sets forth one or more exemplary implementations of a Rating System and Method for On-line Services Auction Marketplace. The inventors intend these exemplary implementations to be examples. The inventors do not intend these exemplary implementations to limit the scope of the claimed present invention. Rather, the inventors have contemplated that the claimed present invention might also be embodied and implemented in other ways, in conjunction with other present or future technologies.

An example of an embodiment of a Rating System and Method for On-line Services Auction Marketplace may be referred to as an “exemplary services auction rater.”

### Incorporation by Reference

The following is incorporated by reference: U.S. patent application Ser. No. ______, entitled “On-line Auction Marketplace for Services”, filed on ______, 2001 and assigned to the Hewlett Packard Corporation.

### Introduction

The one or more exemplary implementations, described herein, of the present claimed invention may be implemented (in whole or in part) by a services rating system 128 and/or by a computing environment.

At least one implementation of the exemplary services auction rater is a rating system and method for an on-line auction marketplace (such as an Internet auction) for services. In such marketplace, services are put up for sale, bid on, and sold. The services are auctioned off.

With the exemplary services auction rater, up-for-auction services (e.g., advertising time slots) are rated. It provides a common rating scale that is used to rate a group of one or more service offerings.

This common rating scale measures services based upon “rating-units” that are different from traditional monetary units. A rating-unit accounts for value (e.g., time-sensitive value) and quantity of the rated service. For example with advertising, an advertisement at 7 p.m. may get five rating-units; while two time slots around 2 a.m. may only get four rating-units.

With this rating scale, one can get a bid via the on-line services auction marketplace for services based upon rating-units. For example, a bidder may bid four rating-units to receive one performances of a service which is of ordinary value. The bidder may bid five rating-units to receive one performance of the same service but at a higher value.

Based upon a universal or personal conversion table, a bidder pays a specified amount of monies per rating-unit.

With this common rating scale, service providers may devise many different combinations of service packages that have different rating-unit levels. Also, a service provider may combine many services into one package and sell that package based upon its combined rating-unit level. This allows an advertiser, for example, to put together “blocks” of advertising that could be bid on all at the same time. These blocks could be, for example, combinations of similarly themed advertisements that are submitted for bidding as a group.

With at least one implementation of the exemplary services auction rater, the rating scale allows for conditional bidding on services. With conditional bidding, a bidder could submit her bid for a particular “block” of services (which have a specified level of rating-units) with the caveat that if she is outbid for that original block (or a portion of that block) that she would have a bid automatically submitted for an alternative block of services, which have the same specified level of rating-units.

In the case of advertising for example, the advertiser may bid on the block of rating-units with the contingency that if any particular time slot within their block exceeded a set limit that the advertiser's bid would automatically shift their advertising to equivalent rating-unit time slots when their maximum bid for a given time slot is exceeded. By establishing a rating-unit scale, bidders can propose their own rating-unit equivalencies (e.g., what time slot exchanges they feel are equivalent value for them).

In this way, advertisers, for example, could establish a rule based on how their advertisements might be shifted, this allows the advertising provider to shift an advertiser's advertisements to equivalent time slots while selling the original time slots. Thus, the advertiser gets their “advertising value” and the advertising provider can fill more of their time slots by providing the same advertising value to the advertiser non-bid-on time slots and selling overbid-on time slots to the highest bidder.

With such a system and method, advertisers may receive credit for services that were preempted or not performed (when scheduled) due to errors or other reasons.

In at least one implementation, the auctioned services have a time-sensitive value, which are those services that may vary in degree of value (based upon the time of performance and factors associated with that time) and, of course, quantity.

Generally speaking, the exemplary services auction rater includes one or more servers hosting a Web site and that site is where services auctioning takes place or is associated with such a site. Sellers place their services there to auction them off to the highest bidder. Potential buyers bid on such services. With the highest bid on a particular service, a potential buyer may purchase the service at the bid price. Typically, these sellers and buyers utilize client computers on a network-such as the Internet.

### Exemplary On-Line Auction Marketplace

The one or more exemplary implementations, described herein, of the present claimed invention may be implemented (in whole or in part) by a services auctioning system 128 and/or by a computing environment.

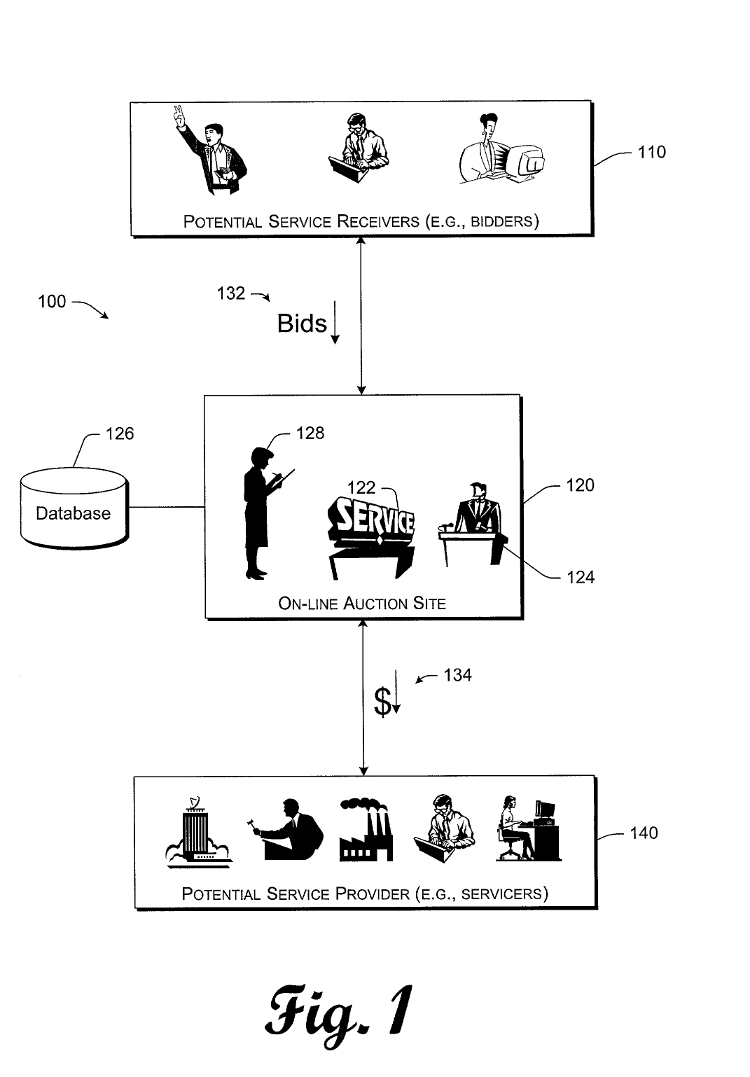

FIG. 1 shows an on-line services auction marketplace 100, which includes the services rating system 128. That system is an implementation of the exemplary services auction rater. The marketplace may also be called an on-line auction marketplace or Internet auction. In such marketplace, services 122 are posted for-sale, bid on, and sold via auction (as represented by a virtual auctioneer 124 in FIG. 1). The services are auctioned off.

Typically, potential service providers 140 place services 122 onto the “virtual” auction block of an on-line auction site 120. By way of example (and not limitation), a service provider 140 may be a movie house with advertising space, a newspaper with advertising space, a graphic designer, an attorney, computer programmer, and the like.

Potential service receivers 110 bid (e.g., bids 132) for the services 122. By way of example (and not limitation), a service receiver 110 may be a corporation wishing to better advertise their products, a business in need of a better designed Web page, an inventor who would like to file a patent application on her invention, and the like.

The on-line auctioneer 124 (as part of the on-line auction site 120) auctions the service. Typically, the highest bidder amongst the potential service receivers 110 wins the auction. With payment (e.g., payment 134), the highest bidder may receive the service 122 from the potential service providers 140. Data regarding such transactions are stored in a database 126.

In at least one implementation, the auctioned services 122 have a time-sensitive value. The rating system 128 provides a scale for rating the up-for-auction services.

Those placing the items for auction may specify a number of rating-units. In so doing, they are assigning a value based upon a common unit of measurement. Of course, this common unit many have most any name, but it is generically called a “rating-unit” herein.

Alternatively, a third party may assign a specific number of rating-units for a service. Such assignment may be based upon objective criteria, subjective criteria, or a combination of both. Example of objective criteria for advertising services may be a statistical estimation of viewership and viewership demographics based upon past results.

This third party may be a human, collection of human, a computer, a collection of computers, or some combination. With experience, a database and knowledgebase system may be instituted to automatically and accurately rate services up-for-auction based on these one or more objective criteria.

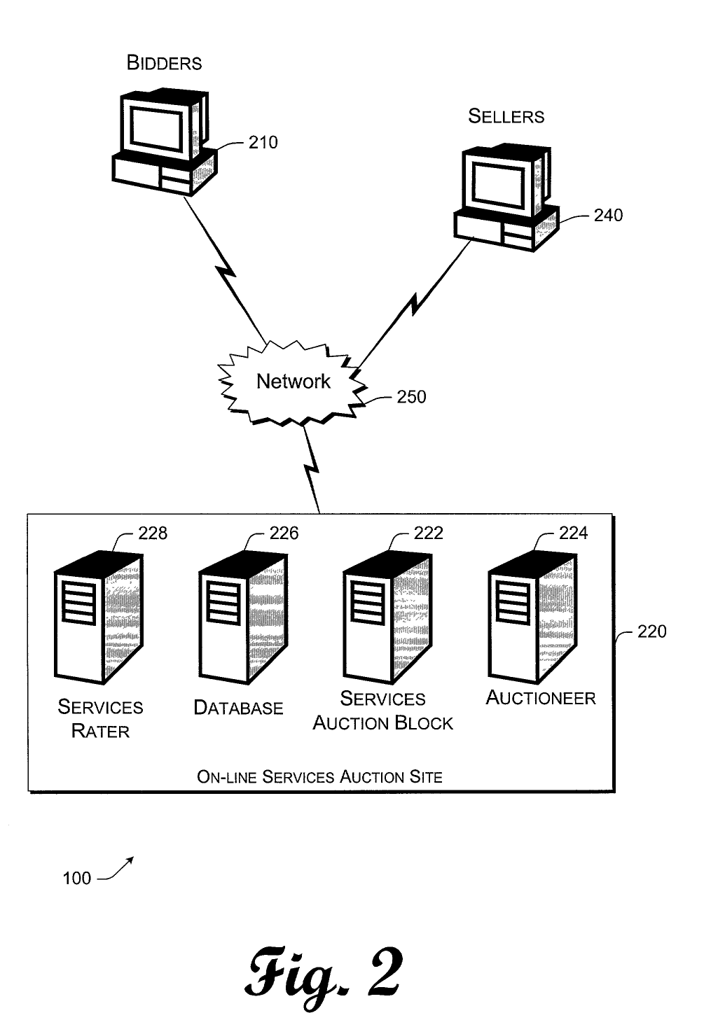

FIG. 2 illustrates the same on-line services auction marketplace 100 of FIG. 1, but in terms of computing components. As shown in FIG. 2, the on-line services auction marketplace 100 includes one or more coupled servers (e.g., servers 222-228) hosting an on-line services auction Web site 220. Services are auctioned via the Web site 220 using, for example, a services-auction-block server 222 for managing services for bid, an auctioneer server 224 for managing the bidding process, and a database 226 for tracking and organizing information related to such auction. It also includes a services rater 228 to perform and/or record ratings of services. These stored ratings or equivalents might be the service provider's ratings, the bidder's personal equivalencies, or a combination of both.

Sellers 240 place their services with the on-line services auction Web site 220 to sell to the highest bidder. Bidders 210 (e.g., potential buyers) bid on the available services. With the highest bid on a particular service, a potential buyer may purchase the service at the bid price.

Typically, these sellers and buyers utilize client computers on a network 250—such as the Internet. This service may be provided by a third party (i.e., “deal maker”) or simply by the seller.

Real-Time Auction

The auction process of the exemplary services auction rater happens in real-time. There is little or no delay between the bidding on a service item and the updating of the bid status on that item.

Furthermore, there may be real-time performance of a service once there is a winning bid. Real-time performance of the service may mean, for example, immediate or near immediate performance upon the official determination of the winning bid. Alternatively, the service may not be performed immediately, but the order to perform the service may be placed immediate (or soon) upon the official the official determination of the winning bid.

If the service was advertising, for example, a bidder may have a prepared and pre-screened advertisement that the service provider can display immediately (or soon after) upon the official determination that the bidder is the winner.

As a result, the auction for a service to be preformed at a specific moment in time may be run until just before the moment. Therefore, the service provider may be able to maximize their return by leaving the item available for bid until just before required performance.

Reversing Roles of Bidders and Sellers

Alternatively, bidding and selling may be reversed. In this scenario, the bidders 210 of the exemplary services auction rater are potential service providers (e.g., servicers 140 of FIG. 1), rather than those wishing to receive a service. Of course, the “sellers” 240 of the exemplary services auction rater are those wishing to receive a service (e.g., service receivers 110 of FIG. 1), rather potential service providers. In this instance, the “sellers” are seeking to buy rather than actually selling.

In this alternative arrangement, the “seller” 240 places its need for a service “on the auction block” of server 222. This service may be generally or narrowly defined. By way of example (and not limitation), a “seller” 240 may be a corporation wishing to better advertise their products, a business in need of a better designed Web page, an inventor who would like to file a patent application on her invention, and the like.

In this alternative arrangement, the bidder 210 is one that believes that they can provide the desired service. The bidder bids for the right to perform the service “on the auction block” at the bid price. By way of example (and not limitation), a bidder 210 may be a movie house with advertising space to sell, a newspaper with advertising space to sell, a graphic designer, an attorney, computer programmer, and the like.

Compensation for Auction Marketplace and Rating System

Typically, the entity providing the on-line services auction site (e.g., 222) and/or the rating service would be compensated for facilitating the services auction and rating the services. Examples of compensations models include the following (provided for examples and not limitation):

a fixed fee paid by the one selling the service, one buying the service, or both;

a fee based upon a portion of the auction price (initial, reserve, and/or final price) which is paid by the one selling the service, one buying the service, or both;

a membership fee;

advertising revenue;

any combination of the above.

Alternatively, the entity providing the on-line services auction site may be a service provider (e.g., 140). This service may be part of a business practice. That is, an entity (such as a television station or movie house) may operate the web site where any potential bidder could bid on various services-for example, advertising time slots.

### Examples of Other Services with Highly Variable Valuation

The value of advertising slots on television (as discussed in the Background section) is an excellent example of a service with a highly variable valuation (i.e., high degree of variable valuation).

The following is a list of examples of other services with highly variable valuations that may be auctioned using at least one implementation of the on-line auction marketplace with the exemplary services auction rater. This non-exhaustive list includes examples of such services by way of examples and not limitation:

advertising in movie houses

advertising in local & regional media (publications, radio, television, the Internet, and the like)

Web page design

patent application drafting

graphic design

computer programming

legal services

brokerage (especially, of stocks, bonds, and commodities) & financial services

shipping of goods

Internet access service

Internet Web page hosting

Internet domain name hosting

Internet E-mail hosting

Internet data storage hosting

### Methodological Implementation of the Exemplary Services Auction Rater

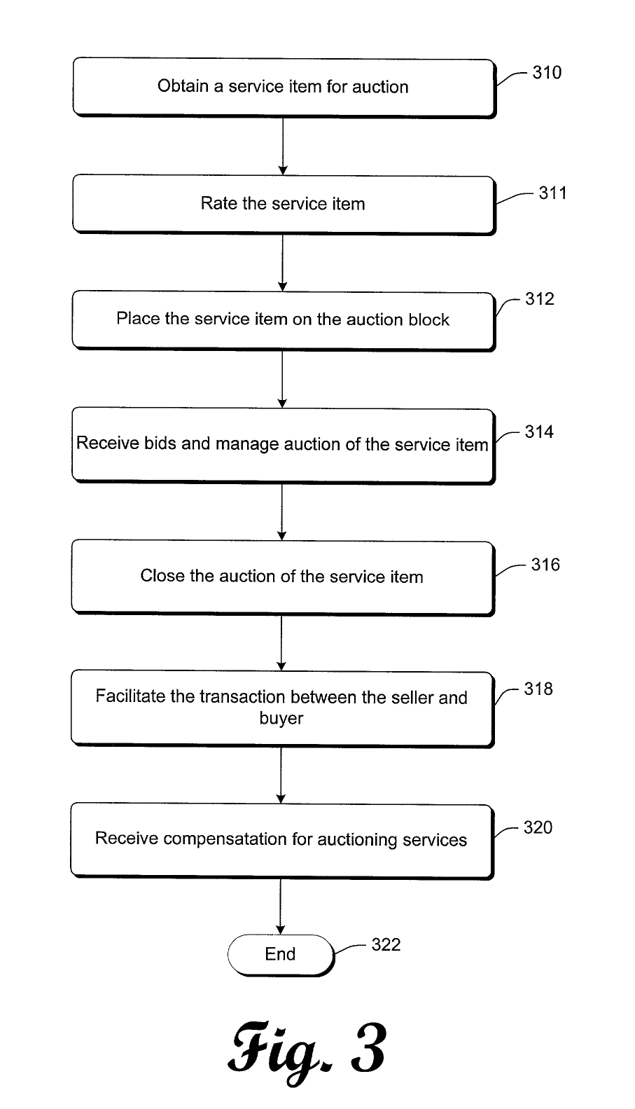

FIG. 3 shows methodological implementation of the exemplary services auction rater performed by the on-line services auction marketplace with the services rating system 128 (or some portion thereof). This methodological implementation may be performed in software, hardware, or a combination thereof.

At 310 of FIG. 3, the services rating system 128 obtains a “service item.” A service item is either an entry of a service to-be-provided or a request for a service to-be-received. Typically, the system obtains the service items by providing a Web site, which may be publicly accessed via the Internet. Users may register general and specific information about themselves and about the service item to be auctioned.

At 311, the service item is rated. This rating may be provided by the one placing the item up for auction. Alternatively, a third party may manually or automatically determine the rating of such item.

At 312, the system places the service item up for auction. Typically, this means that databases are updated to reflect the availability of the service item and its current status information. A page may be statically or dynamically generated for a user of the Web site.

At 314, the system receives bids and manages the auction for the service item. At 316, the system closes the auction of the item. Typically, this is done after a given period of time or if a maximum bid it reached. At that point, the highest bidder wins the right to the service item. If the item is a service, it will be automatically provided to the winning bidder with compensation coming from an open account or on credit. Alternatively, the winning bidder has the right to buy the service at the winning bid. If the item is a request for a service, then the winning bidder is the lowest bidder. That bidder will sell its service at the winning bid price.

At 318, the system facilitates the transaction between the buyer and seller. The system may encourage communication between them. It may act as a third party for exchange of monies for services.

If the system is functioning as a “middle man” to facilitate the auction of other parties, then it may receive compensation at block 320. At 320, the system receives compensation for providing its auction services to the seller and buyer. Examples of the differing kinds of compensation are provided above. At 322, the process ends.

### Exemplary Computer Architecture

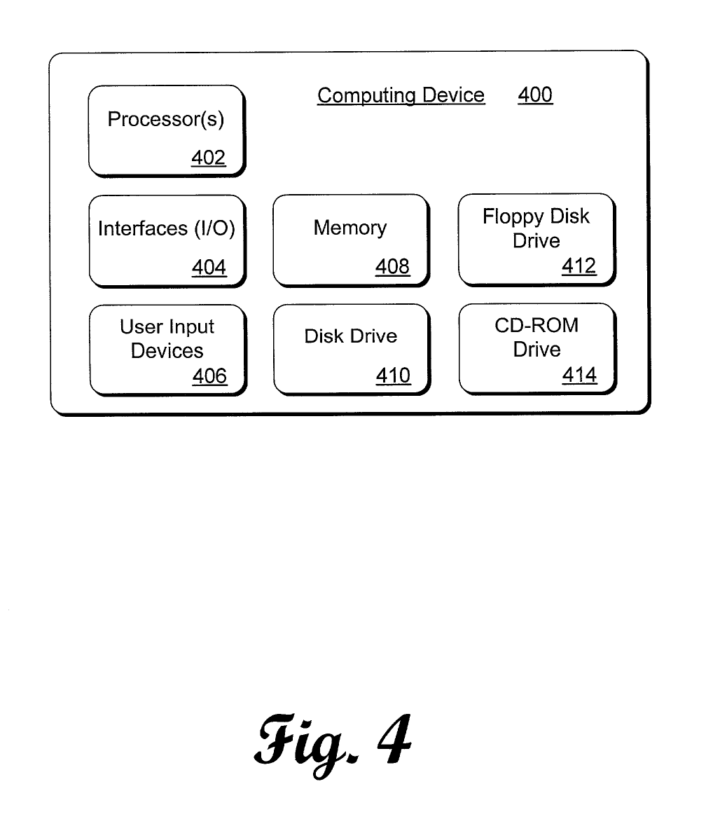

FIG. 4 illustrates various components of an exemplary computing device 400 that can be utilized to implement the exemplary services auction rater. Computer 400 includes one or more processors 402, interfaces 404 for inputting and outputting data, and user input devices 406. Processor(s) 402 process various instructions to control the operation of computer 400, while interfaces 404 provide a mechanism for computer 400 to communicate with other electronic and computing devices. User input devices 406 include a keyboard, mouse, pointing device, or other mechanisms for interacting with, and inputting information to computer 400.

Computer 400 also includes memory 408 (such as ROM and/or RAM), a disk drive 410, a floppy disk drive 412, and a CD-ROM drive 414. Memory 408, disk drive 410, floppy disk drive 412, and CD-ROM drive 414 provide data storage mechanisms for computer 400. Although not shown, a system bus typically connects the various components within the computing device 400.

### Conclusion

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method for facilitating the on-line auction of one or more services, the method comprising:
obtaining a service item for auction;
providing a rating for the service item based upon a common rating scale;
managing an on-line auction for the service item, wherein the managing comprises:
receiving on-line bids for the service item in terms of rating units rather than monetary units;
closing the on-line auction for the service item;
indicating one or more winning bids and one or more winning bidders.

2. A method as recited in claim 1 further comprising receiving compensation from one or more members of a group selected from an auction bidder, an auction participant, a service seller, a service buyer, a service item placer, and a member of an auction.

3. A method as recited in claim 1 further comprising facilitating real-time provision of the service item for the one or more winning bidder, wherein the real-time provision of the service item occurs proximally near in time to the closing.

4. A method as recited in claim 1, wherein the obtaining further comprises receiving information related to the service item via a communications network.

5. A method as recited in claim 1, wherein the managing further comprises receiving real-time bids for the service item via a communications network.

6. A method as recited in claim 1, wherein the service item is a service.

7. A method as recited in claim 1, wherein the service item may have a high degree of variation in valuation.

8. A method as recited in claim 1, wherein the service item has a time sensitive valuation.

9. A method as recited in claim 1, wherein the service item has a time sensitive valuation and is selected from a group consisting of:
advertising;
advertising in movie houses;
advertising in broadcast media;
advertising on the radio;
advertising on television;
advertising on an Internet Web site;
brokerage and financial services;
advertising in printed publications.

10. A method as recited in claim 1, wherein the service item has a time sensitive value, such service is intended to be performed for or by the one or more winning bidders.

11. An on-line marketplace for auctioning services, the marketplace comprising:
a services auction-block computing system configured to obtain a service item for auction;
a services rating computing system configured to provide a rating for the service item for auction based upon a common rating scale;
an auctioneer computing system configured to manage an on-line auction for the service item.

12. A system as recited in claim 11, wherein the auctioneer computing system is further configured to:
receive on-line bids for the service item in terms of rating units rather than monetary units;
close the on-line auction for the service item;
indicate one or more winning bids and one or more winning bidders.

13. A system as recited in claim 11, wherein the service item is a service.

14. A system as recited in claim 11, wherein the service item may have a high degree of variation in valuation.

15. A system as recited in claim 11, wherein the service item has a time sensitive valuation.

16. A system as recited in claim 11, wherein the service item has a time sensitive valuation and is selected from a group consisting of:
advertising;
advertising in movie houses;
advertising in broadcast media;
advertising on the radio;
advertising on television;
advertising on an Internet Web site;
brokerage and financial services;
advertising in printed publications.

17. A system as recited in claim 11, wherein the service item has a time sensitive value, such service is intended to be performed for or by the one or more winning bidders.

18. A computer-readable medium having computer-executable instructions that, when executed by a computer, performs a method for facilitating the on-line auction of one or more services, the method comprising:
obtaining a service item for auction;
providing a rating for the service item based upon a common rating scale;
managing an on-line auction for the service item, wherein the managing comprises:
receiving on-line bids for the service item in terms of rating units rather than monetary units;
closing the on-line auction for the service item;
indicating one or more winning bids and one or more winning bidders.

19. A computer-readable medium as recited in claim 18, wherein the service item is a service.

20. A computer-readable medium as recited in claim 18, wherein the service item may have a high degree of variation in valuation.

21. A computer-readable medium as recited in claim 18, wherein the service item has a time sensitive valuation.

22. A computer-readable medium as recited in claim 18, wherein the service item has a time sensitive valuation and is selected from a group consisting of:
advertising;
advertising in movie houses;
advertising in broadcast media;
advertising on the radio;
advertising on television;
advertising on an Internet Web site;
brokerage and financial services;
advertising in printed publications.

23. A computer-readable medium as recited in claim 18, wherein the service item has a time sensitive value, such service is intended to be performed for or by the one or more winning bidders.
